(19) United States
(12) Patent Application Publication
(10) Pub. No.: US 2003/0049415 A1
(43) Pub. Date: Mar. 13, 2003

(54) Film constructions and methods

(76) Inventors: James J. Pedginski, Stillwater, MN (US); Todd R. Williams, Lake Elmo, MN (US); Dean M. Moren, North St. Paul, MN (US); David J. Kinning, Woodbury, MN (US)

Correspondence Address: MUETING, RAASCH & GEBHARDT, P.A., P.O. BOX 581415, MINNEAPOLIS, MN, 55458, US

(21) Appl. No.: 09/804,085

(22) Filed: Mar. 12, 2001

(51) Int. Cl. B41M 5/00

(52) U.S. Cl. 428/195

(57) ABSTRACT

An image receptor medium including an image reception layer having two major opposing surfaces, wherein the image reception layer includes an amine-functional polymer. Alternatively, the image receptor medium includes a polymer substrate layer having two major opposing surfaces and prime layer on a first major surface of the substrate layer for anchoring an adhesive, wherein the prime layer includes an amine-functional polymer.

### FIELD OF THE INVENTION

The present invention is directed to film constructions, particularly to graphic film constructions that can be used as image receptor media.

### BACKGROUND

Advertising, signage, and promotional displays often include graphic images appearing on structural surfaces such as truck sides and awnings, or free hanging displays such as banners. To prepare the display, an image may be formed on an adhesive-backed image receptor medium, sometimes referred to as a graphic marking film, which is then adhered to the desired substrate. Alternatively, the image may be formed first on a temporary carrier, or image transfer medium, and transferred to the image receptor medium. Images can be created by one of several known methods, such as electrography, screen printing, inkjet printing, and thermal mass transfer.

A typical image receptor medium usually includes a base material with an additional receptor layer overlying it. The base material is typically a plasticized vinyl film. However, more recent products have been introduced that include multilayer film constructions made by an extrusion process, particularly a blown film process, using polyolefin-based polymers. Such constructions are particularly desirable because they are of a lower cost than plasticized vinyl films. A typical film construction is a three-layer film construction that includes an outer layer for image receptivity, a core layer for physical property control, and an inner layer for pressure sensitive adhesive (PSA) anchorage.

Currently, the inner layer of such multilayer film constructions for PSA anchorage is an ethylene vinyl acetate prime layer; however, this prime layer typically must be corona treated for acceptable priming to the typical laminated acrylic PSAs used with graphics sheeting. It would be desirable to eliminate the use of corona treatment because corona treatment can cause the film to block when stored in jumbo roll form for long periods of time (e.g., greater than a month). Furthermore, because in priming a film, a separate coating step is used as well as a separate chemical, radiation, corona, or flame treatment step, expense is added to the cost of making a useful primed film. It is desirable to produce the film and prime layer in one step (e.g., in a coextrusion process).

### SUMMARY OF THE INVENTION

There is a need for film constructions, particularly graphic film constructions such as an image receptor medium, that can be used with a variety of pressure sensitive adhesives (PSAs). Preferably, such PSAs can be used without the need for additional processing steps, such as corona treatment.

In one preferred embodiment, the film construction includes a polymer-containing substrate layer having two opposing major surfaces, a prime layer disposed on a first major surface of the substrate, with an optional tie layer between and in contact with the prime layer and the substrate layer, and a (meth)acrylic adhesive disposed on the prime layer, wherein the substrate layer and prime layer are coextruded (preferably, blown). The prime layer includes an amine-functional polymer, preferably, having an amine number of at least about four. More preferably, the amine-functional polymer is an amine-functional polyamide, and most preferably, an amine-terminated polyamide. Optionally and preferably, the prime layer further includes a polymer selected from the group of an ethylene vinyl acetate, a polyamide, a polyetheramide, a polyurethane, a nylon, a polyester, a polyolefin modified with polar groups, a polyvinyl chloride, a polyacrylate, a polycarbonate, and combinations thereof (e.g., blends or mixtures). More preferably, the prime layer includes an ethylene vinyl acetate polymer. The (meth)acrylic adhesive preferably is a pressure sensitive adhesive.

The film construction is preferably useful as a graphic marking film construction. Preferably, there is an image reception layer on a second major surface of the substrate layer opposite the surface having the adhesive-anchoring prime layer thereon (i.e., the first major surface) with an optional tie layer between and in contact with the substrate layer and the image reception layer. Alternatively, the film construction can be an image receptor medium that includes an image reception layer having two major opposing surfaces, wherein the image reception layer includes an amine-functional polymer. The image reception layer (or medium) also preferably includes a polymer selected from the group of an ethylene vinyl acetate, a polyamide, a polyetheramide, a polyurethane, a nylon, a polyester, a polyolefin modified with polar groups, a polyvinyl chloride, a polyacrylate, a polycarbonate, and combinations thereof. More preferably, in addition to the amine-functional polymer the image reception layer (or medium) further includes an ethylene vinyl acetate (EVA) polymer, even more preferably, an acid- or acid/acrylate-modified EVA polymer, and most preferably a carbon monoxide-modified EVA polymer for receiving images, or combinations thereof. As used herein, “polymer” encompasses homopolymers, copolymers, terpolymers, etc.

The film constructions of the present invention can be used as image receptor media with a variety of printing and image transfer processes, and a variety of imaging materials such as inks and toners. Preferably, if used as image receptor media, the film constructions exhibit image receptivity with a wide variety of printing materials such as screenprint inks, electrographic liquid and dry toners, thermal mass transfer materials, and inkjet inks.

In another embodiment, the present invention provides an image receptor medium that includes a multilayered film. The film includes: a polymer-containing substrate layer having two opposing major surfaces; a prime layer that includes an amine-functional polymer on a major surface of the substrate layer; and a (meth)acrylic pressure sensitive adhesive layer disposed on and in contact with the prime layer. The substrate layer and the prime layer are coextruded (preferably, blown, i.e., produced using a blown film process), and the image receptor medium has less than about 10% adhesive transfer as measured by the Performance Test described in the Examples Section. The pressure sensitive adhesive can be directly coated on the prime layer or transfer coated (i.e., laminated) onto the prime layer. Optionally, the multilayer film of the image receptor medium can include a tie layer between and in contact with the prime layer and the substrate layer and/or a tie layer between and in contact with an image reception layer (having an outer surface for image reception and disposed on a major surface of the substrate layer opposite the major surface on which the prime layer is disposed) and the substrate layer. As discussed above, the amine-functional polymer of the prime layer preferably has an amine number of at least about four, and is more preferably an amine-functional polyamide.

In another embodiment, the present invention provides an image receptor medium that includes an extruded image reception layer having two major opposing surfaces, the extruded image reception layer is preferably blown and includes an amine-functional polymer. The image receptor medium optionally includes an ethylene vinyl acetate polymer, preferably, an acid- or acid/acrylate-modified ethylene vinyl acetate polymer or a carbon monoxide-modified ethylene vinyl acetate polymer, which can be blended with the amine-functional polymer or they can form separate layers. A pressure sensitive adhesive is preferably disposed on one major surface of the image reception layer. The amine-functional polymer preferably has an amine number of at least about four, and is more preferably an amine-functional polyamide.

In yet another embodiment, the present invention provides a multilayered film that includes a polymer-containing substrate layer and having two opposing major surfaces, and an outer layer that includes an amine-functional polymer on a second major surface of the substrate layer opposite the first major surface. In this embodiment, the substrate layer and the outer layer are blown.

In still another embodiment, the invention provides a method of making a film construction that involves coextruding two or more polymers to form a film construction having at least one outer surface that includes an amine-functional polymer. Preferably, the method involves providing at least two polymer charges, each charge including at least one film-forming polymer and one charge including an amine-functional polymer; coextruding the charges to form a multilayered coextrudate, wherein each layer of the coextrudate corresponds to one of the charges. Preferably, the coextrudate can be biaxially stretched (i.e., oriented). Also, preferably, an image reception layer can be applied to a first major surface of the multilayered film. The image reception layer has an outer surface for image reception and preferably includes an ethylene vinyl acetate polymer (EVA), more preferably, an acid- or acid/acrylate-modified EVA polymer, or a carbon monoxide-modified EVA polymer, or combinations thereof.

In the embodiments wherein the film construction includes a substrate layer separate from the layer containing an amine-functional polymer, the film construction can advantageously combine the best properties of several polymers in the various layers while minimizing the use of the most expensive polymers, leading to a higher value and lower cost image receptor medium. For example, the substrate layer is made with polymers of generally low cost that can be chosen to provide specifically desired physical properties to the multilayered film. These properties may include dimensional stability, tear resistance, conformability, elastomeric properties, die cuttability, stiffness, and heat resistance.

For many applications of the film constructions of the present invention, an adhesive is used to attach the construction, which is preferably incorporated into an image receptor medium, to a surface. In many applications, especially shorter term uses (e.g., less than two years), it is desirable to remove the construction including the adhesive as a unit from the surface without leaving any adhesive residue. Such constructions are often referred to as removable. For such applications, there should preferably be a strong bond between the adhesive and the remainder of the construction. The prime layer described herein is intended to provide such a bond.

In other applications, especially longer term uses (e.g., at least two years), environmental exposure may tend to reduce the effectiveness of the adhesive and integrity of the entire construction. Such constructions are often referred to as permanent. As a result, the adhesive chosen may need to be more aggressive and build adhesion to the surface with time.

### BRIEF DESCRIPTION OF THE DRAWINGS

The invention will be further explained with reference to the drawings, wherein:

FIG. 1 is a schematic cross-sectional view illustrating an embodiment of a film construction of the invention including a one-layer image receptor medium that includes an amine-functional polymer;

FIG. 2 is a schematic cross-sectional view illustrating an embodiment of a film construction of the invention including a prime layer disposed on a substrate;

FIG. 3 is a schematic cross-sectional view illustrating a film construction of the invention including the layers shown in FIG. 2 and an optional image reception layer;

FIG. 4 is a schematic cross-sectional view illustrating a film construction of the invention including the layers shown in FIG. 3 and an optional adhesive layer; and

FIG. 5 is a schematic cross-sectional view illustrating a film construction of the invention including the layers shown in FIG. 4 and optional tie layers.

### DETAILED DESCRIPTION OF PREFERRED EMBODIMENTS OF THE INVENTION

The present invention is directed to film constructions, preferably multilayer films that can be used in or as graphic film constructions such as image receptor media. The film constructions of the present invention can be used as graphic film constructions even if they do not receive an image, as occurs with electro-cut films (i.e., colored films electronically cut to form an image). The film constructions of the present invention can also be used in or as tapes, labels, packaging, etc.

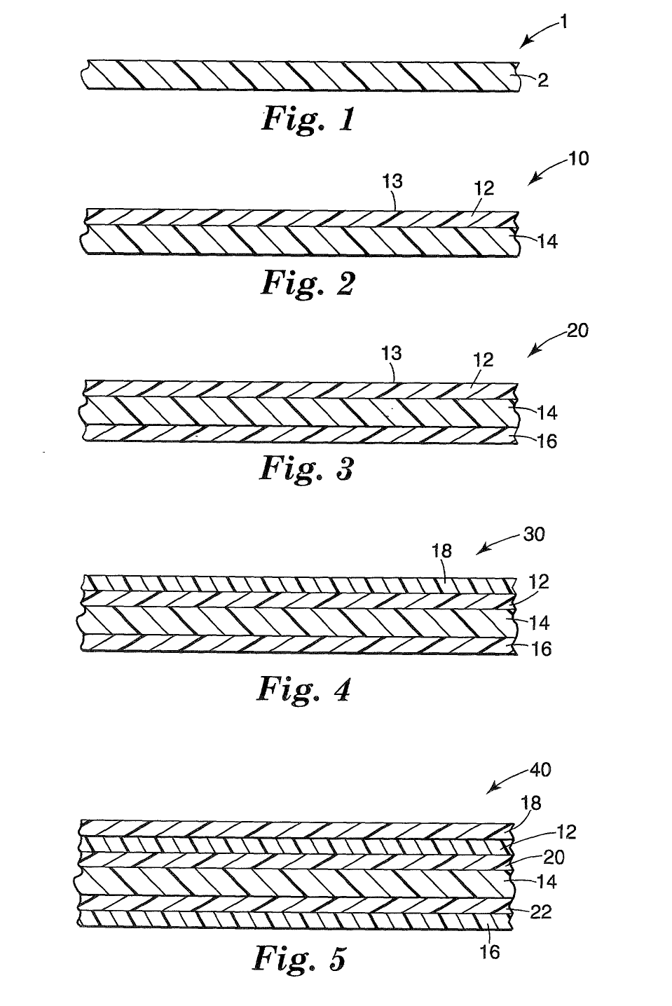

As shown in FIG. 1, in one embodiment of the present invention, the film construction is an image receptor medium 1 that includes a single image reception layer 2 having two major opposing surfaces. The image receptor medium includes an amine-functional polymer.

In another embodiment, as shown in FIG. 2, a film construction 10 of the present invention (which may or may not be used as a graphic film construction, particularly an image receptor medium) includes a substrate layer 14 having two major surfaces and a prime layer 12 overlying and in contact with one major surface of the substrate layer. Prime layer 12 includes an amine-functional polymer. Prime layer 12 has an outer surface 13 for anchoring an adhesive, preferably a (meth)acrylic adhesive, and more preferably, a (meth)acrylic pressure sensitive adhesive.

In another embodiment, as shown in FIG. 3, a graphic film construction 20, which is preferably used as an image receptor medium, includes a substrate layer 14 having two major surfaces and a prime layer 12 overlying and in contact with one major surface of the substrate layer and an image reception layer 16 overlying and in contact with the opposing major surface of the substrate layer 14.

In another embodiment, as shown in FIG. 4, a graphic film construction 30, which is preferably used as an image receptor medium, includes a substrate layer 14 having two major surfaces and a prime layer 12 overlying and in contact with one major surface of the substrate layer 14, an adhesive layer 18 overlying and in contact with the prime layer 12, and an image reception layer 16 overlying and in contact with the opposing major surface of the substrate layer 14.

In another embodiment, as shown in FIG. 5, a graphic film construction 40, which is preferably used as an image receptor medium, includes a substrate layer 14 having two major surfaces and a prime layer 12 overlying one major surface of the substrate layer 14, with a tie layer 20 between the prime layer 12 and the substrate layer 14, an adhesive layer 18 overlying and in contact with the prime layer 12, and an image reception layer 16 overlying the opposing major surface of the substrate layer 14, with a tie layer 22 between the image reception layer 16 and the substrate layer 14. Optionally, a release liner (not shown), such as a silicone release liner, as is well known in the art can be overlying and in contact with the adhesive layer 18.

Amine-Functional Polymer and Mixtures Thereof

An amine-functional polymer is used in the film constructions of the present invention, preferably to anchor an adhesive, which can be directly coated or transfer coated (i.e., laminated) onto the amine-functional polymer. The adhesive is preferably a pressure sensitive adhesive. It is preferably a (meth)acrylic adhesive. The adhesive can be anchored to a substrate layer that is distinct from an image reception layer (as shown in FIG. 3) or directly to an image reception layer (as shown in FIG. 1), through the use of an amine-functional polymer. That is, the amine-functional polymer can be included within an image reception layer. If the amine-functional polymer is in a separate layer from the image reception layer, the layer in which it is incorporated is referred to herein as a prime layer.

The amine-functional polymer and adhesive are chosen such that the image receptor medium has less than 10% adhesive transfer as measured by the Performance Test described in the Examples Section. The amine-functional polymer can include terminal amine groups or amine groups pendant from the backbone of the polymer. Preferably, the amine-functional polymer has an amine number of at least about four, and more preferably, at least about five. There is typically no upper limit to the amine number. The amine number =56100×equivalents amine/grams of polymer. It can be determined by titrating a sample of the polymer with a known amount of hydrochloric acid to give the milliequivalents of amine.

The amine functionality can be primary, secondary, or tertiary. Preferably, the amine groups are not bound to electron-withdrawing groups, such as carbonyl groups. Thus, amide and urethane groups are not preferred amine functionalities. Although the amine functionality is preferably not a part of an amide group, the polymer can be a polyamide. Preferred amine-functional polymers are amine-functional polyamides such as those commercially available under the trade designations MACROMELT 6240 and MACROMELT 6239 from Henkel Adhesives, Elgin, Ill., which have amine numbers of five and six, respectively.

Another suitable amine-functional polymer is an amine-functional polyolefin. One such material, a poly(ethylene-co-butyl acrylate-co-dimethylaminopropylmaleamide acid), is described in the examples and has an amine number of about 19.

The amine-functional polymer may also be mixed (e.g., blended) with one or more other polymers, such as an ethylene vinyl acetate (EVA), a polyamide, a polyetheramide, a polyurethane, a nylon, a polyester, a polyolefin modified with polar groups, a polyvinyl chloride, a polyacrylate, and a polycarbonate. Preferably, the amine-functional polymer is mixed with an ethylene vinyl acetate polymer.

Such compositions are preferred for blown film processes because they have a desirable melt strength for the bubble formed in the process to be maintained. Melt strength of a polymer is typically correlated to melt index, which in turn is usually correlated to molecular weight. Preferably, the EVA or other polymer with which the amine-functional polymer is mixed has a melt index of less than about 8, and more preferably, less than about 6. Also, although typically immiscible, the EVA or other polymer with which the amine-functional polymer is mixed preferably has some level of compatibility with the amine-functional polymer. Compatibility is typically correlated to the polarity of the polymer. For example, polyolefins without polar groups are typically too incompatible with the amine-functional polymer such that the resultant extruded material has very little internal strength. With respect to EVA, polarity, and hence, compatibility, is typically correlated to the vinyl acetate content. Preferably, the EVA polymers include an amount of at least about 5 weight percent (wt-%), and more preferably at least about 12 wt-%, vinyl acetate. Preferably, they include no more than about 28 wt-%, and more preferably, no more than about 18 wt-%, vinyl acetate. Preferred EVA polymers include those commercially available under the trade designation ELVAX (e.g., ELVAX 450, 550, 560, 650Q, 3170, 3174, and 3175), and BYNEL 3101 from DuPont Polymers, Wilmington, Del.

In such compositions, the weight ratio of EVA polymer (or other compatible polymer as discussed above) to amine-functional polymer is preferably at least about-40:60, and more preferably, at least about 50:50. Preferably, the weight ratio of EVA (or other compatible polymer) to amine-functional polymer is no greater than about 90:10, and more preferably, no greater than about 70:30. If more than about 60 wt-% amine-functional polymer is used (based on the total weight of polymers), the cost is increased and the overall melt properties may not be sufficient for use in many blown film processes using conventional extrusion dies, although dies can be designed for such compositions. If less than about 30 wt-% amine-functional polymer is used (based on the total weight of polymers), the priming efficiency decreases, although it may be suitable for certain applications.

Furthermore, it is possible, by using specialized equipment that produces higher shear, to concentrate the amine-functional polymer, which is typically of lower viscosity than the EVA, for example, at the outer surface of the prime layer. See, for example, Ratnagiri, R. and Scott, C. E., “Phase Inversion During Compounding with a Low Melting Major Component: Polycaprolactone/Polyethylene Blends” Polymer Engineering and Science, October 1998, Vol. 38, No. 10, pg 1751-1762; Ratnagiri, R. and Scott, C. E., “Effect of Viscosity Variation with Temperature on the Compounding Behavior of Immiscible Blends” Polymer Engineering and Science, September 1999, Vol. 39, No. 9, pg 1823-1835; Scott, C. E. and Joung, S. K., “Viscosity Ratio Effects in the Compounding of Low Viscosity, Immiscible Fluids into Polymeric Matrices” Polymer Engineering and Science, June 1996, Vol. 36, No. 12, pg 1666-1674; Avgeropoulos, G. N., Weissert, P. H., Biddison, P. H., and Bohm, G. G. A., “Heterogeneous Blends of Polymers Rheology and Morphology” Rubber Chemistry and Technology, 1975, Vol. 49, pg 93-104; Miroshnikov, Y. P., Mikhailovskaya, T. N., and Kuleznev, V. N., “Phase Inversion in Processing Polymer Mixtures” Colloid Journal of the USSR, 1981, Vol. 43, pg 49-55; and Jordhamo, G. M., Manson, J. A., and Sperling, L. H., “Phase Continuity and Inversion in Polymer Blends and Simultaneous Interpenetrating Networks” Polymer Engineering and Science, April 1986,Vol. 26, No. 8, pg 517-524. Thus, it is believed that lower levels of amine-functional polymer (less than 30 wt-% and even less than 10 wt-% amine-functional polymer) can produce effective prime layers, particularly if the ethylene vinyl acetate, for example, and the amine-functional polymers form separate layers.

Optionally, a filler, such as talc, can be mixed with the amine-functional polymer to provide a degree of surface roughness to the amine-functional polymer layer. The filler typically helps prevent blocking (i.e., is an antiblock agent). If used, the filler is preferably present in an amount of at least about 2 wt-%, based on the total weight of the layer containing the amine-functional polymer. Preferably, it is present in an amount of no greater than about 12 wt-%, more preferably, no greater than about 10 wt-%, and most preferably, no greater than about 5 wt-%. The amine-functional polymer can also contain other optional components such as pigments, ultraviolet absorbing agents, antistatic agents, and the like.

Substrate Layer

In one embodiment, a substrate layer 14 is included to reduce the cost and/or enhance the physical properties of the film construction. The substrate layer is most commonly white and opaque for graphic display applications, but could also be colored opaque, white or colored translucent, or transparent. Substrate layer 14 can include any polymer having desirable physical properties for the intended application. Properties of flexibility or stiffness, durability, tear resistance, conformability to non-uniform surfaces, die cuttability, weatherability, heat resistance, and elasticity are examples. For example, a graphic marking film used in short term outdoor promotional displays typically can withstand outdoor conditions for a period in the range from about three months to about one year or more and exhibits tear resistance and durability for easy application and removal.

The material for the substrate layer is preferably a polymer capable of being extruded or coextruded into a substantially two-dimensional film, and more preferably one that is capable of being used in a blown film process. Examples of suitable materials include polyester, polyolefin, polyamide, polycarbonate, polyurethane, polystyrene, acrylic, polyvinyl chloride, and combinations thereof. Preferably, the substrate layer includes a nonplasticized polymer to avoid difficulties with plasticizer migration and staining in the image receptor medium. More preferably, the substrate layer includes medium density (having a density of about 0.92 gram/milliliter (g/ml) to about 0.93 g/ml) polyethylene (MDPE) or a copolymer of polyethylene and polypropylene (PE/PP).

The substrate layer may also contain other additives such as pigments (e.g., TiO₂), fillers, ultraviolet (UV) absorbing agents, UV stabilizers (e.g., that commercially available under the trade designation AMPACET UV 10407 from Ampacet, Tarrytown, N.Y.), thermal stabilizers, antioxidants, antiblocking agents (e.g., talc such as that commercially available under the trade designation MT 5000 from Polyfil Corp., Rockaway, N.J.), antistatic agents, slip agents, and carrier resins for additives such as pigments, processing aids, and the like, all of which are familiar to those skilled in the art. Suitable additives include phenols, phosphates, thioesters, benzophenones, benzotriazoles, hindered amine light stabilizers, and the like. If used, such optional additives are preferably present in an amount of at least about 0.01 wt-%, based on the total weight of the substrate layer. Preferably, they are present in a total amount of no greater than about 10 wt-%.

A typical thickness of the substrate layer 14 is at least from about 10 microns (i.e., micrometers), and generally no greater than about 254 microns. However, the thickness can be outside this range provided, if used in an image receptor medium, the entire film construction is not too thick to feed into the printer or image transfer device of choice. A useful thickness is generally determined based on the requirements of the desired application.

The substrate can be used for image reception, with or without an image reception layer (discussed in greater detail below), with a variety of printing and image transfer processes, and a variety of imaging materials such as screenprint inks, electrographic liquid and dry toners, thermal mass transfer materials, and inkjet inks.

Adhesive

The presence of an adhesive layer makes the image receptor medium useful as a graphic marking film. Although it is preferable to use a pressure sensitive adhesive, any adhesive that is particularly suited to the substrate layer and to the selected application can be used. Such adhesives are those known in the art and may include aggressively tacky adhesives, pressure sensitive adhesives, repositionable or positionable adhesives, hot melt adhesives, and the like.

Preferably, the adhesive is a pressure sensitive adhesive. One well known means of identifying pressure sensitive adhesives is the Dahlquist criterion. This criterion defines a pressure sensitive adhesive as an adhesive having a 1 second creep compliance of greater than 1×10⁻⁶ cm²/dyne as described in Handbook of Pressure Sensitive Adhesive Technology, Donatas Satas (Ed.), 2^{nd} Edition, p. 172, Van Nostrand Reinhold, New York, N.Y., 1989. Alternatively, since modulus is, to a first approximation, the inverse of creep compliance, pressure sensitive adhesives may be defined as adhesives having a Young's modulus of less than 1×10⁶ dynes/cm². Another well known means of identifying a pressure sensitive adhesive is that it is aggressively and permanently tacky at room temperature and firmly adheres to a variety of dissimilar surfaces upon mere contact without the need of more than finger or hand pressure, and which may be removed from smooth surfaces without leaving a residue as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from approximately 2×10⁵ to 4×10⁵ dynes/cm² at a frequency of approximately 0.1 radian/sec (0.017 Hz), and a range of moduli from approximately 2×10⁶ to 8×10⁶ dynes/cm² at a frequency of approximately 100 radians/sec (17 Hz) (for example see FIGS. 8-16 on p. 173 of Handbook of Pressure Sensitive Adhesive Technology (Donatas Satas, Ed.), 2^{nd} Edition, Van Nostrand Rheinhold, N.Y., 1989). Any of these methods of identifying a pressure sensitive adhesive may be used to identify suitable pressure sensitive adhesives for use in the present invention.

Preferably the adhesive is a (meth)acrylic adhesive, and more preferably, a (meth)acrylic pressure sensitive adhesive. Examples of such adhesives are described in U.S. Pat. No. 5,874,143 (Peloquin et al.), Re 24,906 (Ulrich), and International Publication No. WO 96/34066 (Momchilovich et al.), for example. The adhesives may or may not include blends of microspheres and film-forming adhesives.

Generally, (meth)acrylic pressure sensitive adhesives have a glass transition temperature of about −20° C. or less and may include from about 100 wt-% to about 70 wt-% of a C4-C12 alkyl ester component such as, for example, isooctyl acrylate, 2-ethyl-hexyl acrylate, methylbutyl acrylate, and n-butyl acrylate and from 0 to 20 weight percent of a polar component such as, for example, acrylic acid, methacrylic acid, ethylene vinyl acetate, acrylamide, N-vinyl pyrrolidone and styrene macromer. Preferably, the (meth)acrylic pressure sensitive adhesives include from 0 to 20 weight percent of acrylic acid and from 100 to 80 weight percent of isooctyl acrylate. The (meth)acrylic pressure sensitive adhesives may include a tackifier. Useful tackifiers for (meth)acrylics are rosin esters such as that available under the trade name FORAL 85 from Hercules, Inc., Wilmington, Del., aromatic resins such as that available under the trade name PICCOTEX LC-55WK from Hercules, Inc., aliphatic resins such as that available under the trade name PICCOTAC 95 from Hercules, Inc., and terpene resins such as that available under the trade names PICCOLYTE A-115 and ZONAREZ B-100 from Arizona Chemical Co., Wayne, N.J.

Other materials can be added to the adhesive component for special purposes, including, including hydrogenated butyl rubber, pigments, and curing agents to vulcanize the adhesive partially plasticizers, stabilizers, fillers, and the like. Fillers are typically used in amounts from 0 part to 10 parts per 100 parts of pressure sensitive adhesive. Examples of fillers that can be used include zinc oxide, silica, carbon black, pigments, metal powders, and calcium carbonate.

The adhesive layer is preferably covered with a release liner (not shown) that provides protection to the adhesive until the film construction is ready to be applied to a surface.

Examples of adhesive composites intended to be repositionably fixed primarily include graphics-related materials. These materials include large decorative posters for application to a wall. Also contemplated are graphics displays for commercial vehicles that are initially repositionable during application to the vehicle and then become permanently affixed, or such graphics that continue to be removable during the display life of the product.

In embodiments where the adhesive applied to the film is repositionable, the adhesive may be selected from any adhesive that may be repeatably adhered to and removed from a substrate without substantial loss of adhesion capability. An example of such an adhesive is disclosed in U.S. Pat. No. 3,691,140 (Silver), which relates to solid tacky microspheres. Repositionable adhesives are also known in which microspheres contained in the adhesive are non-tacky. A disclosure of this type of adhesive is provided in U.S. Pat. No. 4,735,837 (Miyasaka). Repositionability may also be achieved by other techniques, such as pattern coating of the adhesive.

Preferably, the repositionable adhesive provided on the film includes about 10 wt-% to about 99 wt-% of hollow, polymeric, acrylate, inherently tacky, infusible, solvent-insoluble, solvent-dispersible, elastomeric pressure sensitive adhesive microspheres having a diameter of at least 1 micrometer, and about 1 wt-% to about 90 wt-% of a non-spherical polyacrylate adhesive. These hollow microspheres are made in accordance with the teaching of European Patent Application No. 371,635. The non-spherical polyacrylate adhesive may be any conventional pressure sensitive adhesive. Examples of such adhesives are polymers made from the “soft” monomers such as n-butyl acrylate, isooctyl acrylate, or the like, or copolymers made from a soft component, such as n-butyl acrylate, isooctyl acrylate, ethyl hexyl acrylate, or the like; and a polar monomer such as acrylic acid, acrylonitrile, acrylamide, N,N-dimethylacrylamide, methacrylic acid, or the like. Non-spherical polyacrylate adhesives are commercially available, for example, from Rohm and Haas, Philadelphia, Pa., under the trade designation RHOPLEX and from Minnesota Mining and Manufacturing Co., St. Paul, Minn., under the trade designation FASTBOND 49. Preferably, the non-spherical polyacrylate adhesive is present in the repositionable adhesive at an amount of about 1 wt-% to about 90 wt-%, based on the total weight of the adhesive.

While other repositionable adhesives are generally effective to support films as presently described, the repositionable adhesive with hollow microspheres therein are particularly effective for holding large samples of film to vertical surfaces. This increased holding power is particularly desirable where the film to be supported has a surface area exceeding about 0.3 square meter. When the repositionable adhesive additionally includes a non-spherical polyacrylate adhesive, improved anchorage of the total adhesive to the film is observed, resulting in less adhesive residue being left on the substrate after removal. Also, repositionable adhesives including non-spherical polyacrylate adhesives exhibit excellent shear adhesion properties, even for highly textured vertical surfaces. These advantageous adhesive properties are obtained without excessive adhesion to substrates such as painted walls that would result in peeling of the paint off of the wall when the film adhesive composite is removed. Improved anchorage, shear and adhesion properties are also observed for this adhesive when used with other film backings, such as polyvinyl chloride backings.

Image Reception Layer

The image reception layer can include a variety of materials. It can be imaged with a variety of printing and image transfer processes and a variety of imaging materials. The composition of the image reception layer is typically chosen for the desired imaging method and materials. That is, the composition of the image reception layer should be compatible with the desired imaging method. Depending on the application, the composition of the image reception layer is preferably compatible with underlying layers, abrasion resistant, outdoor durable, and compatible with the desired process (e.g., extrusion process). Preferably, the image reception layer is compatible with a wide variety of imaging methods, is easily processed, and bonds well to the substrate (with or without a tie layer). Such compositions are well known to one of skill in the art. An example of an image reception layer is disclosed in U.S. Pat. No. 5,721,086 (Emslander et al.).

Image reception layer 16 preferably includes an ethylene vinyl acetate (EVA) polymer, such as an acid- or acid/acrylate-modified EVA polymer or a carbon monoxide-modified EVA polymer. These materials include EVA resins blended with polymers having a sufficient amount of acid or acid/acrylate functionality or carbon monoxide functionality to provide an adequate amount of image receptivity for the desired application. A particularly preferred group of acid- or acid/acrylate-modified resins is the BYNEL CXA series 3000 acid/acrylate-modified EVA resins (e.g., BYNEL 3101), commercially available from E.I. DuPont de Nemours and Co., Wilmington, Del. A particularly preferred group of carbon monoxide-modified resins is the ELVALOY resins (e.g., ELVALOY 741), commercially available from E.I. DuPont de Nemours and Co., Wilmington, Del. The added chemical functionality of these resins contributes to their excellent printability and ink adhesion characteristics. Additional printability advantage is obtained by combining the acid- or acid/acrylate-modified resin and a carbon monoxide-modified resin with the EVA.

The quantity of modified EVA resin in the image reception layer is preferably maximized within the limits of performance requirements of the image receptor medium. Routine efforts could be needed to optimize this quantity, although a typical formulation includes at least about 60 wt-%, and preferably, at least about 70 wt-% of the modified EVA resin. The optimum quantity will depend upon the desired application and the targeted cost for the image receptor medium. Other ingredients of the image receptor layer might include fillers, stabilizers, dyes, etc., as discussed below, and inexpensive polymers, such as polyolefins, which can be used for good melt strength and cost reduction, as is known to those skilled in the art.

The modified EVA resin is preferably capable of being extruded or coextruded into a substantially two-dimensional sheet and bonding without delamination to an adjacent substrate layer when the layers are coextruded or laminated. Alternatively, the modified EVA resin may be in the form of a dispersion capable of being coated onto a substrate layer by a method such as roll coating.

The image reception layer may also contain other additives such as pigments (e.g., TiO₂), fillers, ultraviolet (UV) absorbing agents, UV stabilizers (e.g., that commercially available under the trade designation AMPACET UV 10407 from Ampacet, Tarrytown, N.Y.), thermal stabilizers, antioxidants, antiblocking agents (e.g., talc such as that commercially available under the trade designation MT 5000 from Polyfil Corp., Rockaway, N.J.), antistatic agents, slip agents, and carrier resins for additives such as pigments, processing aids, and the like, all of which are familiar to those skilled in the art. Suitable additives include phenols, phosphates, thioesters, benzophenones, benzotriazoles, hindered amine light stabilizers, and the like. These additives are preferably chosen so as not to interfere with image receptivity. If used, such optional additives are preferably present in an amount of at least about 0.01 wt-%. Preferably, each additive is present in an amount of no greater than about 10 wt-%.

If image reception layer 16 is used with a substrate layer 14, image reception layer 16 is relatively thin as compared to substrate layer 14, and preferably has a thickness in the range from about 2.5 microns to about 127 microns. If image reception layer 16 is not associated with a substrate layer 14, then image reception layer 16 may need to be thicker than the above-described range to provide sufficient durability and dimensional stability for the intended application. A thicker image reception layer can increase the overall cost of the image receptor medium.

Tie Layers and Other Optional Layers

It is within the spirit of this invention to include other layers in addition to the image reception layer, the substrate layer, the prime layer, and the adhesive layer described herein. Additional layers may be useful for adding color, enhancing dimensional stability, promoting adhesion between dissimilar polymers in the above-described layers, and the like. These can be used in various combinations.

In preferred embodiments, adhesion of the prime layer and the image reception layer to the substrate layer can be enhanced through the use of tie layers. The selection of such materials can be easily determined by one of skill in the art. For example, tie layers can include EVA polymers such as those commercially available under the trade designation ELVAX (e.g., ELVAX 450, 550, 560, 650Q, 3170, 3174, and 3175) and BYNEL 3101 from DuPont Polymers, Wilmington, Del., and acid-modified methacrylate polymers such as those commercially available under the trade designation NUCREL from DuPont Polymers, Wilmington, Del.

The tie layers can also include additives such as pigments (e.g., TiO₂), fillers, ultraviolet (UV) absorbing agents, UV stabilizers (e.g., that commercially available under the trade designation AMPACET UV 10407 from Ampacet, Tarrytown, N.Y.), thermal stabilizers, antioxidants, antiblocking agents (e.g., talc such as that commercially available under the trade designation MT 5000 from Polyfil Corp., Rockaway, N.J.), antistatic agents, slip agents, and carrier resins for additives such as pigments, processing aids, and the like, all of which are familiar to those skilled in the art. Suitable additives include phenols, phosphates, thioesters, benzophenones, benzotriazoles, hindered amine light stabilizers, and the like.

In other preferred embodiments, after the image receptor medium has been printed with an image, an optional protective overlaminate layer or clear coat (not shown) may be adhered to the printed surface. The overlaminate layer or clear coat improves weather resistance of the film by helping to protect the film from ambient humidity, direct sunlight and other weathering effects, as well as protecting the image from nicks, scratches, and splashes. In addition, the overlaminate layer or clear coat can impart a desired finish to the image, such as high gloss or matte. Suitable overlaminate layers include any suitable transparent plastic sheet material bearing an adhesive on one surface. Such overlaminate layers are well known to those of skill in the art, as are clear coats.

In still other preferred embodiments, the film construction of the present invention can include an inkjet layer (not shown). Such inkjet layers are used when the image receptor medium will receive images using water-based inks, solvent-based inks, UV-cured inks, and the like, which are well known to those of skill in the art. The inkjet layer is preferably used when the image receptor medium will receive images from a thermal inkjet printer using water-based inkjet inks (either dye-based or pigment-based) to provide characteristics of dye bleed resistance, low fading, uniform fading and rapid drying. In one embodiment, the inkjet layer includes two layers, the uppermost of which (top coat) functions as a protective penetrant layer to rapidly take up the water-based ink while the bottom coat functions as an inkjet receptor. The formulation of such inkjet layers is well known to those of skill in the art.

Making the Image Receptor Medium

The image receptor medium of this invention can be made by a number of methods. For example, various of the layers can be coextruded using any suitable type of coextrusion die and any suitable method of film making such as blown film extrusion or cast film extrusion. Preferably, at least the prime layer and the substrate layer are coextruded in a blown film extrusion process. For the best performance in coextrusion, the polymeric materials for each layer are chosen to have similar properties such as melt viscosity. Techniques of coextrusion are found in many polymer processing references, including Progelhof, R. C., and Throne, J. L., Polymer Engineering Principles, Hanser/Gardner Publications, Inc., Cincinnati, Ohio, 1993. Alternatively, one or more of the layers may be extruded as a separate sheet and laminated together to form the film construction. One or more of the layers may also be formed by coating an aqueous or solvent-based dispersion onto one or more previously extruded layers. This method is less desirable because of the extra process steps and the additional cost and waste involved.

It is believed that the adhesive layer can be coextruded with the other layers, although more typically it is transferred to the image receptor medium from a liner, or directly coated onto the image receptor medium in an additional process step.

The finished film construction can be subjected to a surface treatment method such as corona treatment, if desired, to improve the image receptivity of the image receptor layer for certain applications. Corona treatment may also be used to enhance the strength of the bond between the primer and the adhesive. However, it is preferred to use a prime layer that works well without corona treatment.

Use of the Film Constructions

The film constructions of the present invention can be used in a wide variety of applications. They can be used as image receptor media. They can be used as graphic film constructions even if they do not receive an image, as occurs with electro-cut films (i.e., colored films electronically cut to form an image). The film constructions of the present invention can also be used in or as tapes, labels, packaging films, wall coverings, decorative ribbons, etc.

Imaging materials that can be used in accordance with the present invention include a wide variety of materials that include pigments or dyes to provide contrast or color to the deposited image. Inks and toners are examples of well known imaging materials. They can be in a wet or dry form. The imaging materials may be deposited by a variety of known techniques such as electrography, screen printing, knife or roll coating, rotogravure coating, inkjet printing (e.g., thermal or piezo), and the like.

### EXAMPLES

The invention is further illustrated by the following examples, but the particular materials and amounts thereof recited in these examples, as well as other conditions and details, should not be construed to unduly limit this invention.

Performance Test

Samples of adhesive-coated film constructions were razor cut to a one-inch (2.54-centimeter (cm)) width and a length of about 8 inches (20 cm). If present, the silicone release liner was removed and the sample was adhered to an etched and desmutted aluminum panel (available from Q Panel Company, Inc., Cleveland, Ohio) by rubbing down firmly with 3 passes of a hand squeegee. Panels were then placed in an environment appropriate for testing. These environments included 150° F. (66° C.) for 5 days and room temperature (22° C.) water soak for 5 days.

After being in the appropriate environment for the required time period, the panels were removed. The panels stored at 150° F. (66° C.) were allowed to cool to room temperature. The panels soaked in water at room temperature were padded dry.

Next, the sample strips were peeled back by hand rapidly at 180 degrees. Observations were made as to the amount of adhesive transfer to the aluminum panel and the type of failure. Failure at the adhesive/primer interface is called a ply failure (designated by P) and failure at the primer/substrate interface is called a delamination (designated by D). Prime layers demonstrating acceptable priming of the adhesive have adhesive transfer of less than 10%. Hence, “5P” means 5% adhesive transfer upon ply failure.

### Example 1

ELVAX 3170 EVA pellets obtained from DuPont were extruded into a 4-mil (0.01-cm) thick sheet by using a ¾%-inch (2-cm) BRABENDER extruder having 3 heating zones and using a general-purpose polyolefin type extrusion screw with mixing element. The extruder temperatures were set up as follows: Zone 1=130° C.; Zone 2=160° C.; Zone 3=180° C.; and the die and die adapter were set to 200° C. The extruder screw speed was adjusted to about 80 revolutions per minute (rpm). The 4-mil (0.01-cm) thick film was extruded onto a 2-mil (0.005-cm) thick polyester (PET) film.

Next the exposed surface of the ELVAX 3170 EVA layer was transfer coated with a removable microsphere-based pressure sensitive acrylate adhesive. The adhesive was a blend of a dispersion of hollow tacky microspheres prepared as described in WO 92/13924, Example 1, and a nonspherical acrylate adhesive commercially available from Minnesota Mining and Manufacturing Co., St. Paul, Minn., under the trade designation FASTBOND 49, at a ratio of 46 to 54. This blend was first coated onto a silicone release liner at a wet thickness of 3 mils (0.008 cm), and then dried at 150° F. (66° C.) for ten minutes. Finally the adhesive was laminated to the ELVAX 3170 EVA surface by running through a laminating nip set at 60 pounds per square inch (psig) (0.4 megapascals).

After adhesive lamination, the 2-mil (0.005-cm) PET carrier film was peeled from the adhesive coated ELVAX 3170 EVA film at a 180-degree angle. Next, an adhesive-coated film available under the trade designation Series 60-13 red SCOTCHCAL ELECTROCUT available from Minnesota Mining and Manufacturing Company, St. Paul, Minn. was laminated to the freshly exposed ELVAX 3170 EVA surface by running through a lamination nip set at 60 psig (0.4 megapascal). The purpose of using the Series 60-13 product was to provide some reinforcement to the prime layer during performance testing. This composite was then allowed to sit for 24 hours at room temperature to allow the bond to build between the adhesive being tested and the prime layer being evaluated. For this example, the ELVAX 3170 EVA had a 100% ply (100P) failure for the 150° F. (66° C.) test and a 50% ply (50P) failure for the water soak test. Thus ELVAX 3170 EVA polymer alone does not pass the performance testing as a prime layer for this particular adhesive.

### Example 2-13

Pellets of MACROMELT 6239 amine-functional polyamide from Henkel Corp. were dry blended with pellets of ELVAX 3170 EVA from DuPont at the weight ratios specified in Table 1. These materials were processed at the same temperatures as that of Example 1 and tested using the same adhesive coating procedure as that of Example 1. The results are in Table 1 below.

TABLE 1

| | | MACROMELT | | |
|---|---|---|---|---|
| | | 6239 Amine- | Water Soak at | |
| | ELVAX 3170 | functional | Room | 150° F. |
| | EVA (Weight | Polyamide | Temperature | (66° C.) |
| Example | Percent) | (Weight Percent) | (5 days) | (5 days) |
| 1 | 100 | 0 | 50P | 100P |
| 2 | 90 | 10 | 20P | 100P |
| 3 | 80 | 20 | D | 100P |
| 4 | 70 | 30 | 5P | 90P |
| 5 | 60 | 40 | 0P | 0P |
| 6 | 50 | 50 | 10P | 0P |
| | BYNEL 3101 | MACROMELT | | |
| | Acid/Acrylate- | 6239 Amine- | Water Soak at | |
| | Modified EVA | functional | Room | 150° F. |
| | (Weight | Polyamide | Temperature | (66° C.) |
| Example | Percent) | (Weight Percent) | (5 days) | (5 days) |
| 7 | 100 | 0 | 100P | 90P |
| 8 | 90 | 10 | 90P | 100P |
| 9 | 80 | 20 | 0P | 50P |
| 10 | 70 | 30 | 0P | 50P |
| 11 | 60 | 40 | 0P | 0P |
| 12 | 50 | 50 | 2P | 0P |
| 13 | 75 | 25 | 0P | 20P |

As can be seen by this data, to pass the water soak test at least about 20 percent (wt-%) MACROMELT 6239 amine-functional polyamide is in the prime layer formulation. To pass the 150° F. (66° C.) test, at least 0 wt-% MACROMELT 6239 amine-functional polyamide is desired in e layer formulation.

### Example 14

A blown film construction was made having 5 layers using a 7-layer blown film die. The materials used in each layer were as follows and are based on ratios by weight.

| Extruder 1: | Outer Prime Layer: MACROMELT 6239/ELVAX 560 at |
|---|---|
| | 50/50. Materials were first pre-compounded and made |
| | into pellets by using a twin-screw extruder. |
| Extruder 2: | Tie Layer: BYNEL 3101/AMPACET UV 10407 at |
| | 95.5/4.5. |
| Extruders | Core (Substrate) Layer: FINA Z9470/AMPACET |
| 3, 4, 5: | 8707/AMPACET UV 10407 at 78.5/17.0/4.5. |
| Extruder 6: | Tie Layer: BYNEL 3101/AMPACET UV 10407 at |
| | 95.5/4.5. |
| Extruder 7: | Inner (Image Reception) Layer: BYNEL |
| | 3101/ELVALOY 741/MT 5000/AMPACET UV 10407 at |
| | 78/22/5/4.5. |

AMPACET UV 10407 UV stabilizer (available from Ampacet, Tarrytown, N.Y.).

FINA Z9470 propylene/ethylene copolymer at 6% ethylene (available from Atofina Petrochemicals, Houston, Tex.).

MT 5000 talc (available from Polyfil Corp., Rockaway, N.J.).

AMPACET 8707 white concentrate (TiO₂) (available from Ampacet, Tarrytown, N.Y.).

The extruder conditions used for this example are shown below in Table 2.

TABLE 2
Blown Film Example 14

| Extruder | No. 1 | No. 2 | No. 3 | No. 4 | No. 5 | No. 6 | No. 7 |
|---|---|---|---|---|---|---|---|
| Zone 1 | 280° F. | 340° F. | 340° F. | 340° F. | 340° F. | 340° F. | 300° F. |
| | (138° C.) | (171° C.) | (171° C.) | (171° C.) | (171° C.) | (171° C.) | (149° C.) |
| Zone 2 | 340° F. | 380° F. | 380° F. | 360° F. | 360° F. | 360° F. | 330° F. |
| | (171° C.) | (193° C.) | (193° C.) | (182° C.) | (182° C.) | (182° C.) | (166° C.) |
| Zone 3 | 370° F. | 390° F. | 380° F. | 380° F. | 370° F. | 370° F. | 350° F. |
| | (188° C.) | (199° C.) | (193° C.) | (193° C.) | (188° C.) | (188° C.) | (177° C.) |
| Zone 4 | | | | | 380° F. | 380° F. | 370° F. |
| | | | | | (193° C.) | (193° C.) | (188° C.) |
| Adapter | 380° F. | 380° F. | 380° F. | 380° F. | 390° F. | 380° F. | 370° F. |
| | (193° C.) | (193° C.) | (193° C.) | (193° C.) | (199° C.) | (193° C.) | (188° C.) |
| Die | 380° F. | 380° F. | 380° F. | 380° F. | 380° F. | 380° F. | 380° F. |
| | (193° C.) | (193° C.) | (193° C.) | (193° C.) | (193° C.) | (193° C.) | (193° C.) |

Line Speed = 31 feet per minute (FPM) (9.4 meters/minute)
Blow Up Ratio = 1.4
Caliper = 4.0 mil (0.01 cm)

The layer distribution was that as shown below with the prime layer being about 15% of the total layer thickness (from Extruder 1). Layer Distribution: Extruder 1=15%; Extruder 2=8%; Extruders 3,4,5=55%; Extruder 6=7%; Extruder 7=15%.

Next, a pressure sensitive adhesive as described in Examples 2-12 was transfer coated onto the prime layer. (Note: Series 60 film was not used here to reinforce the prime layer for testing.) After 24 hours the samples were prepared for performance testing. The results are shown in Table 3 below.

### Example 15

The film construction was made the same as that in Example 14 except the prime layer composition used was pre-compounded ELVAX 560/MACROMELT 6239/talc at 47.5/47.5/5. The talc was added as an antiblock agent and is commercially available under the trade designation TALC 399 (available from Whittaker Clark & Daniels South Plainfield, N.J.). The primer was transfer coated with the pressure sensitive adhesive described in Example 1. After 24 hours the samples were prepared for performance testing. The results are shown in Table 3 below.

### Example 16

The film construction of Example 15 was transfer coated with a different meth(acrylic) pressure sensitive adhesive than in Example 15. This is considered a permanent (meth)acrylic pressure sensitive adhesive (containing 70:22.5:7.5 isooctyl acrylate/methyl acrylate/acrylic acid (molecular weight of 2.0×10⁵) crosslinked with 4-acryloxybenzophenone photocrosslinker to a gel fraction of 80% measured in tetrahydrofuran (THF), prepared as described in U.S. Pat. No. 5,874,143 (Peloquin et al.). After 24 hours the samples were prepared for performance testing. The results are shown in Table 3 below.

TABLE 3

| | | MACROMELT | | | |
|---|---|---|---|---|---|
| | ELVAX | 6239 Amine- | TALC | Water Soak at | |
| Ex- | 560 EVA | functional | 399 | Room | 150° F. |
| am- | (Weight | Polyamide | (Weight | Temperature | (66° C.) |
| ple | Percent) | (Weight Percent) | Percent) | (5 days) | (5 days) |
| 14 | 50 | 50 | 0 | 0P | 0P |
| 15 | 47.5 | 47.5 | 5 | 0P | 0P |
| 16 | 47.5 | 47.5 | 5 | 0P | 0P |

### Examples 17-22

The film constructions prepared in Examples 7 to 12 were again used in this series of examples. This time the primer layer was coated with a different pressure sensitive adhesive (containing 96:4 2-methylbutyl acrylate/acrylamide (molecular weight of 2.0×10⁵) crosslinked with benzophenone photocrosslinker to a gel fraction of 65% measured in tetrahydrofuran (THF), prepared as described in U.S. Pat. No. 5,874,143 (Peloquin et al.). The same testing procedure was followed as in Example 1. The results of this testing is shown in Table 4 below.

TABLE 4

| | | MACROMELT | | |
|---|---|---|---|---|
| | BYNEL 3101 | 6239 | Water Soak | |
| | Acid/Acrylate- | Amine-functional | at Room | 150° F. |
| | Modified EVA | Polyamide | Temperature | (66° C.) |
| Example | (Weight Percent) | (Weight Percent) | (5 days) | (5 days) |
| 17 | 100 | 0 | 100P | 100P |
| 18 | 90 | 10 | 100P | 100P |
| 19 | 80 | 20 | 100P | 0P |
| 20 | 70 | 30 | 100P | 0P |
| 21 | 60 | 40 | 0P | 0P |
| 22 | 50 | 50 | 0P | 0P |

### Example 23

Aminated Polyethylene Preparation. Poly(ethylene-co-butyl acrylate-co-maleic anhydride) (240.0 grams, 0.0857 equivalents anhydride, Aldrich #43,085-4, melt index (190° C./2.16 kg) 5 grams/10 minute, 5.5 weight percent butyl acrylate, 3.5 weight percent maleic anhydride) was dissolved in toluene (360 grams) at 110° C. N,N-dimethyl-1,3-propanediamine (8.74 grams, 0.0857 mole) and toluene (100 grams) were added, the mixture was refluxed for 6 hours, then poured into two 8-inch×12-inch (20-cm×30-cm) aluminum pans. The cooling mixture quickly formed a soft wax and was mechanically crumbled. The crumbs were allowed to dry under ambient conditions for 16 hours, then dried under pump vacuum at 75° C. for 2 hours.

This poly(ethylene-co-butyl acrylate-co-dimethylaminopropylmaleamide acid) was processed as described in Example 1 except the extrudate was cast onto a 3 layer polyolefin film. The surface used for casting had a composition of 78/22 BYNEL 3101/ELVALOY 741 to promote anchorage of the extrudate to the polyolefin carrier film.

Next, the acrylate pressure sensitive adhesive as described in Example 1 was transfer coated onto the prime layer surface. This sample was tested the same as that described in Example 1 and demonstrated 10% ply (10P) failure for the 150° F. (66° C.) test and a 10% ply (10P) failure for the water soak test.

### Example 24

An acrylate latex pressure sensitive adhesive commercially available from Union Carbide, UCAR Emulsion Systems, Cary, N.C., under the trade designation UCAR 9189 was diluted to a nominal 40% solids by weight using deionized water. The viscosity of this solution was raised using a thickener commercially available from Rohm and Haas Co., Philadelphia, Pa., under the trade designation ACRYSOL ASE-60, and a solution of 28% ammonia in water (from EM Science, Gibbstown, N.J.) to maintain a pH of approximately 9. The viscosity of the final solution was nominally 2000 centipoise (cps) using a Brookfield LVT Viscometer, Spindle #3 at 30 RPM (Brookfield Engineering Laboratories Inc., Stoughton, Mass.). Before coating, a crosslinker commercially available from Sybron Chemicals Inc., Birmingham N.J. under the trade designation XAMA 7 was added at a level of 0.6 gram per 100 grams of adhesive. The adhesive was coated and bonded to the film described in Example 11 in the same manner as described in Example 1. For both conditions of evaluation, 0% prime failure was observed, there was no adhesive residue left on the panel.

| | BYNEL 3101 | MACROMELT | | |
|---|---|---|---|---|
| | Acid/Acrylate | 6239 | Water Soak | |
| | -Modified | Amine-functional | at Room | 150° F. |
| | EVA (Weight | Polyamide (Weight | Temperature | (66° C.) |
| Example | Percent) | Percent) | (5 days) | (5 days) |
| 24 | 60 | 40 | 0P | 0P |

### Example 25

Using the extruder conditions of Example 1, a dry blend (70/30) of SURLYN 1705-1 (an ethylene/methacrylic acid copolymer available from DuPont) and MACROMELT 6239 was extrusion cast at 4 mils (0.01 cm) onto a 2-mil (0.005 cm) PET film. The adhesive of Example 1 was directly coated onto the SURLYN/MACROMELT surface at a 3-mil (0.08 cm) wet coating thickness. The sample was dried in an oven at 150° F. (66° C.) for 10 minutes. The adhesive surface was laminated to a release liner. The PET was then stripped from the composite and an adhesive-coated film available under the trade designation Series 60-13 red SCOTCHCAL ELECTROCUT available from Minnesota Mining and Manufacturing Company, St. Paul, Minn. was laminated to the freshly exposed SURLYN/MACROMELT surface to provide reinforcement for testing purposes, as in Example 1. The samples were tested as in Example 1. After 5 days, the results were as follows: water soak test=OP; and 150° F. (66° C.) test=3P.

### Example 26

A 4-mil (0.01-cm) thick film of a 75/25 blend (by weight) of BYNEL 3101/MACROMELT 6239 as described in Example 13 was extruded using a ¾-inch (2-cm) Brabender extruder. No precompounding of the resins was done: however, a screw with a mixing element was used in the extruder. The extruder temperatures were as follows: zone 1=130° C., zone 2=170° C., and zone 3=180° C., while the necktube and die were at 200° C. The films were screenprinted with either 1905 solvent based ink or 9705 UV curable ink, both available from Minnesota Mining and Manufacturing Co., St. Paul, Minn. Subsequently, the ink adhesion was tested using the procedure described in U.S. Pat. No. 5,721,086 (Emslander et al.). In this test a razor blade is used to crosshatch the printed surface and then SCOTCH Tape No. 610 from Minnesota Mining and Manufacturing Co., St. Paul, Minn., is applied to the crosshatched area and removed using a sharp jerk. For both 1905 and 9705 ink, none of the ink was removed from the printed films, indicating good adhesion of the inks.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A film construction comprising:
a substrate layer comprising a polymer and having two opposing major surfaces; and
a prime layer comprising an amine-functional polymer disposed on a first major surface of the substrate layer; and a (meth)acrylic adhesive disposed on the prime layer;
wherein the substrate layer and prime layer are coextruded.

2. The film construction of claim 1 wherein the (meth)acrylic adhesive is a pressure sensitive adhesive.

3. The film construction of claim 1 wherein the coextruded substrate layer and prime layer are blown.

4. The film construction of claim 1 wherein the amine-functional polymer has an amine number of at least about four.

5. The film construction of claim 1 wherein the amine-functional polymer is an amine-functional polyamide or an amine-functional polyolefin.

6. The film construction of claim 5 wherein the amine-functional polyamide is an amine-terminated polyamide.

7. The film construction of claim 1 which is a graphic marking film construction.

8. The film construction of claim 7 further comprising an image reception layer on a second major surface of the substrate layer opposite the first major surface, wherein the image reception layer comprises an acid- or acid/acrylate-modified ethylene vinyl acetate polymer.

9. The film construction of claim 8 further comprising a tie layer between and in contact with the substrate layer and the image reception layer.

10. The film construction of claim 7 further comprising an image reception layer on a second major surface of the substrate layer opposite the first major surface, wherein the image reception layer comprises a carbon monoxide-modified ethylene vinyl acetate polymer.

11. The film construction of claim 10 further comprising a tie layer between and in contact with the substrate layer and the image reception layer.

12. The film construction of claim 1 wherein the polymer of the substrate layer is selected from the group consisting of polyolefin, polyester, polyamide, acrylic, polystyrene, polyurethane, polycarbonate, polyvinyl chloride, and combinations thereof.

13. The film construction of claim 12 wherein the polymer of the substrate layer is a propylene-ethylene copolymer or medium density polyethylene.

14. The film construction of claim 1 wherein the prime layer further comprises a polymer selected from the group of an ethylene vinyl acetate, a polyamide, a polyetheramide, a polyurethane, a nylon, a polyester, a polyolefin modified with polar groups, a polyvinyl chloride, a polyacrylate, a polycarbonate, and combinations thereof.

15. The film of claim 14 wherein the prime layer further comprises an ethylene vinyl acetate.

16. The film construction of claim 1 further comprising a tie layer between and in contact with the prime layer and the substrate layer.

17. The film construction of claim 16 further comprising an image reception layer on a second major surface of the substrate layer opposite the first major surface, wherein the image reception layer comprises an acid- or acid/acrylate-modified ethylene vinyl acetate polymer or a carbon monoxide-modified ethylene vinyl acetate polymer.

18. An image receptor medium comprising a multilayered film comprising:
a substrate layer comprising a polymer and having two opposing major surfaces;
a prime layer comprising an amine-functional polymer on a major surface of the substrate layer; and
a (meth)acrylic pressure sensitive adhesive layer disposed on and in contact with the prime layer;
wherein the substrate layer and the prime layer are coextruded, and the image receptor medium has less than about 10% adhesive transfer.

19. The image receptor medium of claim 18 wherein the pressure sensitive adhesive is applied to the prime layer by directly coating the adhesive on the prime layer.

20. The image receptor medium of claim 18 wherein the pressure sensitive adhesive is applied to the prime layer by transfer coating.

21. The image receptor medium of claim 18 wherein the coextruded substrate layer and prime layer are blown.

22. The image receptor medium of claim 18 further comprising a tie layer between and in contact with the prime layer and the substrate layer.

23. The image receptor medium of claim 22 further comprising an image reception layer on a major surface of the substrate opposite the major surface on which the prime layer is disposed, and a tie layer between and in contact with the image reception layer and the substrate layer, wherein the image reception layer comprises an acid- or acid/acrylate-modified ethylene vinyl acetate polymer or a carbon monoxide-modified ethylene vinyl acetate polymer.

24. The image receptor medium of claim 18 further comprising an image reception layer on a major surface of the substrate opposite the major surface on which the prime layer is disposed, and a tie layer between and in contact with the image reception layer and the substrate layer, wherein the image reception layer comprises an acid- or acid/acrylate-modified ethylene vinyl acetate polymer or a carbon monoxide-modified ethylene vinyl acetate polymer.

25. The image receptor medium of claim 18 wherein the amine-functional polymer has an amine number of at least about four.

26. The image receptor medium of claim 18 wherein the amine-functional polymer is an amine-functional polyamide or an amine-functional polyolefin.

27. An image receptor medium comprising an extruded image reception layer having two major opposing surfaces, the extruded image reception layer comprising an amine-functional polymer.

28. The image receptor medium of claim 27 further comprising a polymer selected from the group of an ethylene vinyl acetate, a polyamide, a polyetheramide, a polyurethane, a nylon, a polyester, a polyolefin modified with polar groups, a polyvinyl chloride, a polyacrylate, a polycarbonate, and combinations thereof.

29. The image receptor medium of claim 28 further comprising an ethylene vinyl acetate polymer.

30. The image receptor medium of claim 29 wherein the ethylene vinyl acetate polymer is an acid- or acid/acrylate-modified ethylene vinyl acetate polymer.

31. The image receptor medium of claim 29 wherein the ethylene vinyl acetate polymer is blended with the amine-functional polymer.

32. The image receptor medium of claim 29 wherein the ethylene vinyl acetate polymer and the amine-functional polymer form separate layers.

33. The image receptor medium of claim 27 further comprising a pressure sensitive adhesive disposed on one major surface of the image reception layer.

34. The image receptor medium of claim 27 wherein the extruded image reception layer is a blown film.

35. The image receptor medium of claim 27 wherein the amine-functional polymer has an amine number of at least about four.

36. The image receptor medium of claim 27 wherein the amine-functional polymer is an amine-functional polyamide or an amine-functional polyolefin.

37. A multilayered film comprising:
a substrate layer comprising a polymer and having two opposing major surfaces; and
an outer layer comprising an amine-functional polymer on a second major surface of the substrate layer opposite the first major surface;
wherein the substrate layer and the outer layer are blown.

38. A method of preparing a film construction, the method comprising coextruding two or more polymers to form a film construction having two opposing major surfaces, at least one outer surface comprising an amine-functional polymer.

39. The method of claim 38 wherein coextruding comprises providing at least two polymer charges, each charge including at least one film-forming polymer and at least one charge including at least one amine-functional polymer; coextruding the charges to form a multilayered coextrudate, wherein each layer of the coextrudate corresponds to one of the charges.

40. The method of claim 39 further comprising biaxially stretching the multilayered coextrudate.

41. The method of claim 38 wherein the film construction further includes an image reception layer comprising an acid- or acid/acrylate-modified ethylene vinyl acetate polymer or a carbon monoxide-modified ethylene vinyl acetate polymer.

42. The method of claim 38 further comprising applying a layer of pressure sensitive adhesive to the outer surface comprising the amine-functional polymer.

43. The method of claim 42 wherein coextruding comprises blowing the two or more polymers.

44. A film construction made by the method of claim 38.

45. A film construction preparable by a method comprising coextruding two or more polymers to form a film construction having two opposing major surfaces, at least one outer surface comprising an amine-functional polymer.
